(19) United States
(12) Patent Application Publication
(10) Pub. No.: US 2009/0007100 A1
(43) Pub. Date: Jan. 1, 2009

(54) Suspending a Running Operating System to Enable Security Scanning

(75) Inventors: Scott A. Field, Redmond, WA (US); Brandon Baker, Redmond, WA (US)

Correspondence Address: LEE & HAYES PLLC, 601 W Riverside Avenue, Suite 1400, SPOKANE, WA, 99201, US

(73) Assignee: Microsoft Corporation, Redmond, WA (US)

(21) Appl. No.: 11/769,916

(22) Filed: Jun. 28, 2007

(51) Int. Cl. G06F 9/455; H04L 9/32

(52) U.S. Cl. 718/1

(57) ABSTRACT

Techniques described herein enable virtualizing a processor into one or more virtual machines and suspending an operating system of one of the virtual machines from outside of the operating system environment. Once suspended, these techniques capture a snapshot of the virtual machine to determine a presence of malware. This snapshot may also be used to determine whether an unauthorized change has occurred within contents of the virtual machine. Remedial action may occur responsive to determining a presence of malware or an unauthorized change.

### BACKGROUND

Processors within computing devices often include privileged and unprivileged modes. Software running in a privileged mode is generally able to execute every instruction supported by the processor. Typically, the operating system kernel runs within the privileged mode, which is sometimes referred to as “Ring 0”, “Supervisor Mode”, or “Kernel Mode”.

In contrast, some software running on the computing device may be constrained to run only in an unprivileged mode. This mode generally allows the software to execute a subset of the processor's instructions. An operating system can thus use the unprivileged mode to limit the activity of software running in this mode. For example, software might be restricted to a particular subset of the computing device's memory. This unprivileged mode is sometimes known as “Ring 3” or “User Mode”. In general, computing-device user applications operate in this unprivileged mode.

If a software application operates in this unprivileged mode, the application may request access to a portion of memory that cannot be directly accessed from the unprivileged mode. The application may, for example, wish to perform an operation in this portion of memory such as “create a new file”. This request is typically routed through a call gate or other system call instruction, which transitions this unprivileged-mode code into privileged-mode code. This transition ensures that the unprivileged mode does not have direct access to memory that is designated as accessible from privileged mode only.

In accordance with these modes, an author of malicious code may access the privileged mode through a vulnerability or administration error and install malware that changes the behavior of the computing device. This malware may, for instance, alter the location of files, hide files, modify files, change keystrokes, or the like. Some of this malware may comprise a “rootkit”, which not only changes the computing device's behavior but also hides itself within the privileged mode's memory. Antivirus applications running on the computing device may accordingly fail to discover this hidden rootkit, thus allowing the malware to continue compromising system security. Furthermore, such malware may patch over an operating system's built-in protection system.

A malware author may access the privileged mode and load malware onto a computing device in a variety of ways, including by tricking the computing-device user into unknowingly installing the malware onto the user's own computing device. As a result, current operating systems often employ one or more protection systems to detect such malware. These protection systems generally monitor certain important operating-system resources to detect any changes to these resources.

If such a protection system detects such a change, then the protection system may decide that the particular resource has been infected by malware. These protection systems may also provide, to the user's antivirus application, a list of applications currently resident in the unprivileged mode's memory. Of course, if the malware was successful in hiding, then it will not appear on the provided list. Furthermore, if the malware was successful in patching the protection system the protection system may fail to run or otherwise fail to detect any changes to the important operating-system resources.

While these protection systems can be effective, they can also suffer from a few weaknesses. First, these systems often rely on obscurity and are thus vulnerable to exploitation if identified by the malware. That is, if the malware deciphers the identity of and locates the protection system, it may disable the protection system itself. The malware author may also instruct others on how to do the same. Furthermore and related to the first, these protection systems generally operate in a same protection domain as that of the operating system (e.g., within the privileged mode itself). Therefore, the protection system is itself subject to attack if the malware gains access to the privileged mode and is able to unmask the obscured protection system. Finally, these protection systems initialize at the same time as the operating system or privileged mode. Therefore, if the malware or malware author gains control of the computing device before this initialization, it may prevent the protection system from initializing.

### SUMMARY

This document describes techniques capable of virtualizing a processor into one or more virtual machines and suspending an operating system of one of the virtual machines from outside of the operating system environment. Once suspended, these techniques capture a snapshot of the virtual machine to determine a presence of malware. This snapshot may also be used to determine whether an unauthorized change has occurred within contents of the virtual machine. Remedial action may occur responsive to determining a presence of malware or an unauthorized change.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), and/or computer-readable instructions, as permitted by the context above and throughout the document.

### BRIEF DESCRIPTION OF THE DRAWINGS

The detailed description is described with reference to accompanying figures. In the figures, the left-most digit(s) of a reference number identifies the figure in which the reference number first appears. The use of the same reference numbers in different figures indicates similar or identical items.

FIG. 1 depicts an illustrative computing device in which various embodiments of the techniques may operate. As illustrated, this computing device includes a host and a virtual machine monitor that together suspend an operating system running within a corresponding virtual machine.

FIG. 2 depicts illustrative components of the virtual machine monitor and host of FIG. 1.

FIG. 3 is a flow diagram for virtualizing a processor into a virtual machine and suspending an operating system corresponding to the virtual machine.

FIG. 4 is a flow diagram for receiving a request to suspend an operating system associated with a virtual machine and suspending the operating system. Once suspended, contents of the virtual machine may be scanned or logged before the operating system resumes or remedial action occurs.

### DETAILED DESCRIPTION

The following document describes techniques capable of suspending a running operating system of a virtual machine from outside the operating system's environment. Once suspended, a state of the virtual machine may be captured before the operating system resumes. This state may be inspected for malicious code, compared against prior states, compared against physical contents of memory, and/or the state or some data associated with the state may be logged. This discussion begins by describing an illustrative environment in which the claimed techniques may be implemented. The discussion then proceeds to describe illustrative processes that may utilize these techniques.

Illustrative Environment

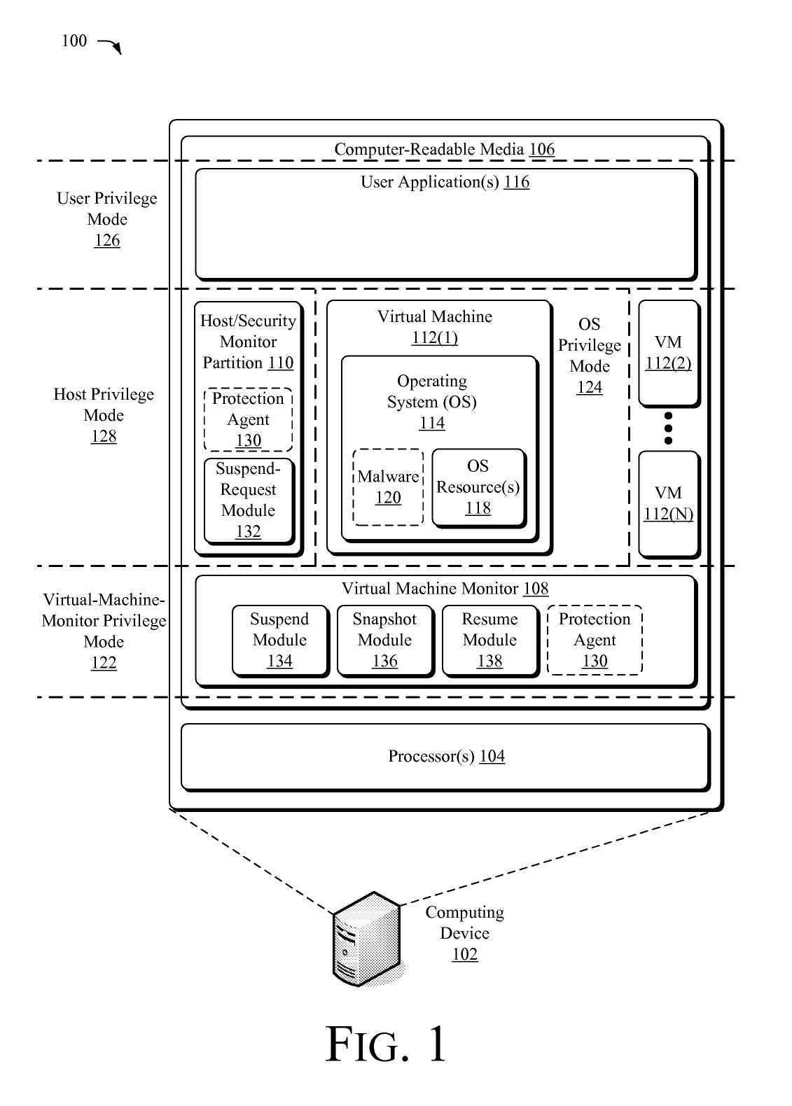

FIG. 1 depicts an illustrative environment 100 in which the claimed techniques may be implemented. Environment 100 described below constitutes but one example and is not intended to limit application of the techniques to any one particular operating environment. Other similar or different environments may be used without departing from the spirit and scope of the claimed subject matter.

Environment 100 includes a computing device 102, which itself includes one or more processors 104 as well as computer-readable media 106. Computer-readable media 106 include a virtual machine monitor 108 (e.g., a hypervisor), which enables virtualization of the one or more processors into one or more virtual processors. Virtual machine monitor 108 may also enable virtualization of the computer memory as well as other devices associated with or coupled to the computing device into one or more virtual machines. Each virtual machine may be associated with one or more virtual processors, which are scheduled onto the available physical processors.

As illustrated, virtual machine monitor 108 virtualizes the processors and other devices of the computing device into a host 110 as well as virtual machines 112(1), 112(2), . . . , 112(N). Note that host 110 may also comprise a dedicated security monitor partition 110 in some implementations. In these implementations, dedicated security monitor partition 110 is granted many of the same privileges as a host, and contains similar or the same components as discussed below with regard to host 110. It is noted that the term “dedicated security monitor partition 110” may generally be used interchangeably with the term “host 110” throughout the document.

Also as illustrated, virtual machine 112(1) runs an operating system (OS) 114. Each of virtual machines 112(2)-(N) may similarly run a respective operating system. Operating system 114, as well respective operating systems of virtual machines 112(2)-(N), enables user applications 116 to run on the computing device. As such, a user operating virtual machine 112(1) may utilize operating system 114 to access and run one or more of user applications 116. Note that the particular user applications that may be accessed depends upon the configuration of virtual machine 112(1). That is, the subset of user applications 116 that a user may run on virtual machine 112(1) likely differs from the subset of user applications 116 that the user may run on virtual machine 112(2) or 1 12(N).

In addition, one or more operating-system resources 118 reside on operating system 114. Exemplary resources include a system service dispatch table (SSDT), an interrupt dispatch table (IDT), a global descriptor table (GDT), and other data structures used by the operating system. Also as illustrated, operating system 114 may or may not include malware 120 (i.e., code with malicious intent), which may have been loaded onto the computing device in the ways discussed above or otherwise. In some instances, malware 120 may alter or attempt to alter operating-system resources 118.

In addition to the structure of computing device 102, environment 100 also illustrates varying privilege modes present on the underlying one or more physical processors 104. An application running on computing device 102 operates within one of these privilege modes, which determines which portion(s) of computing device 102 the application may access.

A virtual-machine-monitor privilege mode 122 represents the most privileged mode illustrated in FIG. 1. This privilege mode has access to all or substantially all of the device's resources and memory. From virtual-machine-monitor privilege mode 122, virtual machine monitor 108 may schedule processors and allow access to areas of memory for each virtual machine. While an operating system running within a virtual machine may believe that it controls all of the resources of a physical processor, in actuality it only controls a portion as determined by virtual machine monitor 108.

Less privileged than the virtual-machine-monitor privilege mode, an operating-system privilege mode 124 for virtual machine 112(1) has access to operating-system resources 118 and most or all operating-system memory. This privilege mode, however, does not have access to any resources or memory associated with other virtual machines, such as virtual machines 112(2)-(N). Nevertheless, because this privilege mode generally has access to all of the operating-system memory, it is sometimes referred to as the “Privileged Mode”, “Ring 0”, “Supervisor Mode”, or “Kernel Mode”. As discussed above, a user application operating within operating-system privilege mode 124 is generally able to execute most instructions provided by the processor, with the exception of those instructions reserved for virtual-machine-monitor privilege mode 122. In addition, operating-system privilege modes may exist for each of virtual machines 112(2)-(N).

Operating-system privilege mode 124 is contrasted with a user privilege mode 126, sometimes referred to as “Unprivileged Mode”, “Ring 3”, or simply “User Mode”. Also as discussed above, the user application may not access or alter certain memory associated with the operating system (e.g., the kernel) when operating from user privilege mode 126. In general, computing-device user applications operate in this user privilege mode when performing basic operations.

Finally, FIG. 1 illustrates a host privilege mode 128. When operating within host privilege mode 128, an application or other entity may not only access contents of host (or dedicated security monitor partition) 110, but also contents of one or more of virtual machines 112(1)-(N). For instance, host 110 operating within host privilege mode 128 may, in some instances, be allowed access to virtual machine 112(1) as well as corresponding operating system 114.

Returning to the components depicted within computing device 102, host (or dedicated security monitor partition) 110 and/or virtual machine monitor 108 may include a protection agent 130. Protection agent 130 detects changes made to operating-system resources 118 by malware 120. In response to such detection, protection agent 130 may take remedial action or may instruct another entity to do so. The agent may, for instance, shut down the operating system and/or the computing device.

As illustrated, virtual machine monitor 108 operates within virtual-machine-monitor privilege mode 122, while host 110 operates within host privilege mode 128. Operating system 114 of virtual machine 112(1), meanwhile, operates within operating-system privilege mode 124, which does not have access to virtual machine monitor 108 or host 110. As such, malware 120 cannot access protection agent 130 within virtual machine monitor 108 and/or host 110. This is true even if malware 120 resides within the deepest layer of the operating system (i.e., the kernel). Malware 120 may thus not patch over a request to run protection agent 130, nor may malware 120 hide itself from the protection agent. As illustrated, virtual machine monitor 108 and/or host 110 thus ensure that protection agent 130 monitors operating-system resources 118 and virtual machine 112(1) for malware 120. In implementations that employ dedicated security monitor partition 110 instead of host 110, malware 120 similarly cannot access protection agent 130 within this partition or within virtual machine monitor 108.

To help this monitoring of virtual machine 112(1), virtual machine monitor 108 and/or host 110 may suspend operating system 114 to capture a state or snapshot of the operating system and of corresponding virtual machine 112(1). This state or snapshot may then be inspected for malware 120 or may be used for other purposes. For instance, this state may be compared against prior states or snapshots. This state may also be logged for future inspection, to maintain a history of virtual machine 112(1), or for other purposes.

To begin suspension, host 110 includes a suspend-request module 132. Suspend-request module 132 sends a request to virtual machine monitor 108 to suspend operating system 114 associated within virtual machine 112(1). This request may occur in response to one or more triggers. For instance, suspend-request module 132 may request suspension according to a periodic schedule (e.g., hourly, daily, etc.). This request may also be sent randomly or on-demand.

In addition, host 110 and/or virtual machine monitor 108 may request suspension and inspection of operating systems corresponding to one or more of virtual machines 112(2)-(N) in response to discovering malware 120 or an unauthorized change within virtual machine 112(1). When this occurs, virtual machines 112(2)-(N) may be inspected serially, at the same time, randomly, or according to any other schedule. While a few suspension triggers have been listed, multiple other triggers are similarly envisioned.

To receive a request to suspend operating system 114, virtual machine monitor 108 includes a suspend module 134. Virtual machine monitor 108 also includes a snapshot module 136 and a resume module 138. Suspend module 134 receives the suspend request and suspends operating system 114. Suspending the operating system includes suspending all run-time behavior of operating system 114. For instance, progress of each thread running within the operating system is suspended. Servicing of interrupts for virtual machine 112(1) similarly ceases. In some instances, however, only portions of the operating system may be suspended. Here, some threads may be suspended while others may continue to run. Similarly, some interrupts may be serviced, while others may not.

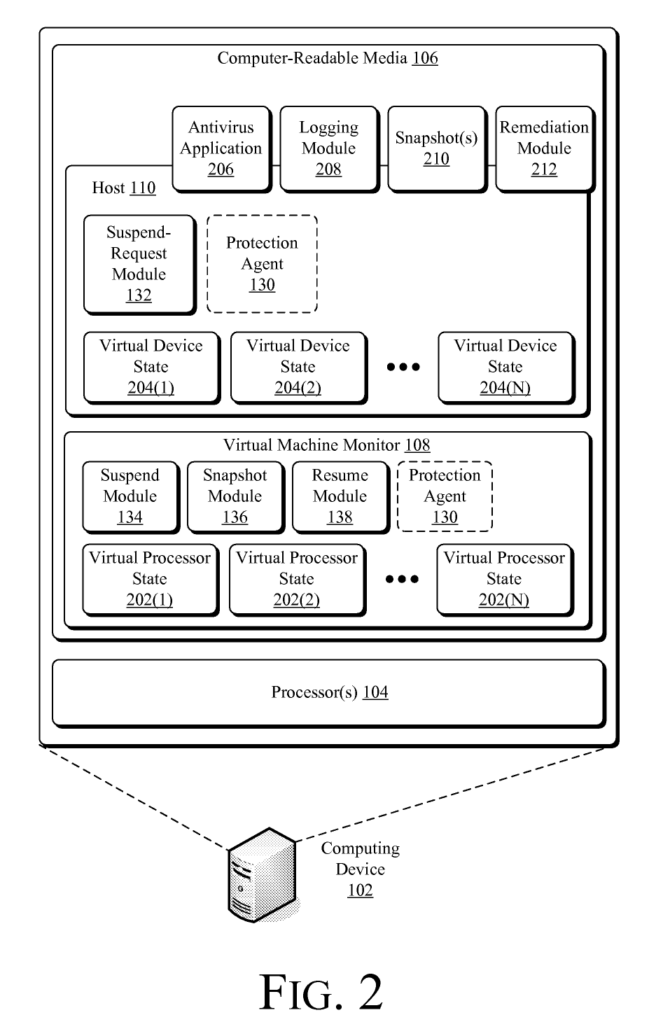

Once operating system 114 is suspended, snapshot module 134 captures a state or snapshot of virtual machine 112(1). This state may include any content associated with virtual machine 112(1), including a virtual processor state, a virtual device state, and memory contents, as discussed in detail below with reference to FIG. 2.

Protection agent 130 may then inspect this captured state to determine whether malware 120 resides within virtual machine 112(1). Protection agent 130 may also compare this captured state to one or more prior states to, for instance, determine if any unauthorized changes have occurred within virtual machine 112(1). If this snapshot includes memory contents of virtual machine 112(1), then protection agent 130 may also compare these memory contents against what is on the portion of the computing device's disk assigned to virtual machine 112(1).

Responsive to determining the presence of malware 120 and/or one or more unauthorized changes within virtual machine 112(1), protection agent 130 may trigger one or more remedial actions. For instance, protection agent 130 may trigger a shut down of operating system 114 and, hence, of virtual machine 112(1). Protection agent 130 may instead trigger a reboot of operating system 114. Additionally, protection agent 130 could trigger a suspend and scan of one or more virtual machines 112(2)-(N). Protection agent 130 could alternatively or additionally trigger removal of virtual machine 112(1) from a network to which the machine couples or may otherwise limit the virtual machine's network access. Protection agent 130 may also trigger a reboot of operating system 114 and instruct operating system 114 to undergo an antivirus scan before loading again. Finally, protection agent 130 may trigger alteration of a piece of data that was changed without authority before resuming operating system 114. These illustrative remedial actions are discussed in detail below.

Having suspended and scanned virtual machine 112(1), resume module 138 resumes operating system 114 in instances where no remedial action occurs (e.g., where no malware or unauthorized changes were detected within the captured snapshot). To do so, resume module 138 reactivates any suspended threads running within operating system 114. Resume module 138 also re-enables servicing of interrupts within virtual machine 112(1). In some instances, the state or snapshot captured by snapshot module 136 is inspected before operating system 114 resumes. In other instances, operating system 114 resumes close in time after the state or snapshot is captured. The snapshot is then inspected, logged, and/or utilized after resumption of the operating system. Note that in some instances, operating system 114 is suspended in a manner and for a length of time that is unperceivable to a user of virtual machine 112(1).

As illustrated and described with reference to FIG. 1, computing device 102 enables suspension and inspection of a running operating system from outside the operating system's environment. This not only enables inspection of the operating system while it runs, but also prohibits malware 120 operating within operating-system privilege mode 124 from impeding this suspension and inspection. As such, operating system 114 may be suspended and inspected at periodic intervals and, in response to detecting malware or unauthorized changes, operating system 114 may undergo one or more forms of remedial action.

FIG. 2 depicts additional illustrative components of virtual machine monitor 108 and host 110 from FIG. 1 in more detail. These components illustrate a specific implementation in which environment 100 may suspend an operating system, capture a snapshot for inspection, and resume the operating system. Again, FIG. 2 and the corresponding discussion describe but one implementation and other implementations are similarly envisioned.

In addition to components discussed above with reference to FIG. 1, FIG. 2 illustrates that virtual machine monitor 108 includes virtual processor states 202(1), 202(2), . . . , (N), each of which corresponds to a respective one virtual machines 112(1)-(N). Each of virtual processor states 202(1)-(N) includes content of processor registers associated with processors 104 for a respective virtual machine. Virtual machine monitor 108 maintains this content so that the processor registers are restored with each machine's content when processors 104 return to a particular virtual machine.

For instance, virtual machine monitor 108 maintains virtual processor state 202(1) for virtual machine 112(1). When processors 104 cease running virtual machine 112(1) and begin running virtual machine 112(2), the content of the processor registers for virtual machine 112(1) is saved within virtual processor state 202(1). When processors 104 resume running virtual machine 112(1), the content of the processor registers within virtual processor state 202(1) is then restored for use by virtual machine 112(1).

Host 110, meanwhile, includes virtual device states 204(1), (2), . . . , (N), each of which also correspond to a respective one of virtual machines 112(1)-(N). Each of virtual device states 204(1)-(N) includes contents of peripheral devices for the respective virtual machine. These peripheral devices may include any hardware devices that couple to or associate with computing device 102, such as a disk, a network card, a video card, a mouse, a USB device, and/or the like. The contents within virtual device states 204(1)-(N) denote which devices a respective virtual machine is privileged to access and in what capacity the virtual machine may access them. For instance, virtual device state 204(1) denotes the devices and corresponding privileges corresponding to virtual machine 112(1).

To suspend an operating system such as operating system 114, suspend-request module 132 again issues a request to virtual machine monitor 108 to suspend the operating system. Suspend module 134 receives this request and suspends any threads currently running on operating system 114. Because these threads become suspended, the contents of virtual processor state 202(1) becomes frozen or static. In addition, virtual device state 204(1) located on host 110 becomes similarly frozen or static.

At this point, host 110 may ask for a copy of virtual processor state 202(1). Virtual machine monitor 108 may accordingly copy virtual processor state 202(1) and provide this copy to host 110. Host 110 now contains virtual device state 204(1) and a copy of virtual processor state 202(1). In addition, Host 110 has access to the contents of the memory within virtual machine 112(1). Host 110 may thus inspect some or all of this state associated with operating system 114.

In other implementations, meanwhile, virtual machine monitor 108 inspects some or all of this state with use of protection agent 130 and/or in the manners discussed below. In still other implementations, virtual machine monitor 108 inspects a portion of the state (e.g. virtual processor state 202(1)) while host 110 inspects another portion of the state (e.g., virtual device state 204(1)).

In the current example, however, host 110 inspects the state associated with virtual machine 112(1). Having access to virtual processor state 202(1), virtual device state 204(1), and contents of memory for virtual machine 112(1), host 110 may inspect this state or transmit this state for inspection in a number of ways. To do so, host 110 may be integral with, accessible by, or separate from one or more of an antivirus application 206, a logging module 208, one or more snapshots 210, and/or a remediation module 212. Policy of each of these components may be configurable by a user, system administrator, or another entity. Again, host 110 may also include or be accessible by protection agent 130, whose policy may also be configurable.

With use of these components, host 110 inspects the state associated with virtual machine 112(1) in an attempt to detect malware 120 and/or unauthorized changes to operating-system resources 118 or the like. In some instances, host 110 or another entity (e.g., protection agent 130) inspects only a portion of the state, such as executable pages, static portions, or the like. By inspecting only a portion of this state, operating system 114 may be suspended for a shorter amount of time. This shorter suspension may be less noticeable to a user of virtual machine 112(1).

In some instances, protection agent 130 inspects virtual processor state 202(1), virtual device state 204(1) and/or the contents of memory for virtual machine 112(1). Protection agent 130 inspects this state to detect a presence of malware 120, a change in operating-system resources 118, illegitimate drivers loaded in the kernel, or any other problem with the state. In response to such detection, protection agent 130 may take or instruct another entity to take some remedial action. In addition, host 110 or some other entity may perform intrusion detection and forensics in response to determining malware 120 or an unauthorized change to the inspected state. By doing so, host 110 or the other entity may pinpoint the time and/or source of the original security breach, both of which may be logged in a manner discussed below.

Host 110 may also transmit some or all of this state to antivirus application 206. Antivirus application 206 inspects this state to determine if virtual processor state 202(1), virtual device state 204(1), and/or contents of memory for virtual machine 112(1) contain malware 120 or some other virus. Again, antivirus application 206 triggers some remedial action responsive to such a determination.

Host 110 may also send some or all of the state associated with virtual machine 112(1) to logging module 208. Logging module 208 may then log this state for future inspection or for some other use. Additionally or alternatively, host 110 may send some data associated with this state to logging module 208. For instance, host 110 may choose to log the fact that virtual machine 112(1) was suspended and scanned on a certain date and time. Host 110 may also send results of a scan to logging module 208 for logging, along with an indication of what was scanned (e.g., memory, virtual processor state, etc.). Note that some or all of this data may be logged locally and/or remotely. In the latter instances, this data could be sent to a remote monitoring system (e.g., a remote computer and/or a network to device) to archive the data and/or to perform some administrative action, such as disabling network access.

Once a state or snapshot of virtual machine 112(1) is captured, host 110 may also compare this state or snapshot against previous snapshots stored as snapshots 210. This current snapshot may be compared to a previous snapshot to determine differences between the two. Each of snapshots 210 may represent a state of virtual machine 112(1) at a time prior to the current suspending. This previous snapshot may represent the state of the virtual machine when previously suspended or may represent the state of the virtual machine when offline. In some instances, static portions of the state of virtual machine 112(1) may be compared to static portions of a prior snapshot from snapshots 210. Here, dynamic or writable portions of the state may be compared when desired, and in some cases would not be compared. In some instances, host 110 may choose not to compare the dynamic portions of the state in order to save the performance overhead that would otherwise be spent while undergoing such a comparison. In addition, if expected values of the dynamic portions of the state cannot be predicted, then host 110 may likewise choose not to compare these portions. Finally, if the compared snapshots or portions of the snapshots do not match, then remedial action may be triggered.

In addition to comparing a captured state against one or more snapshots 210, host 110 may also compare this state against a static content of the disk for virtual machine 112(1). Here, host 110 or some other entity (e.g., protection agent 130) determines whether the running kernel in memory matches the kernel image on the disk. Host 110 or the other entity may also determine whether code loaded into memory originated from a digitally signed file. This examined code may comprise an executable file, a device driver, a dynamic link library (DLL) file, and/or the like. Again, if the running kernel does not match the kernel image on the disk, or if host 110 determines that the examined code loaded into memory did not originate from a digitally signed file, then some remedial action may be triggered.

Finally, remediation module 212 may take remedial action responsive to a determination that malware 120 exists within state associated with virtual machine 112(1). Remediation module 212 may also act in response to detecting an unauthorized change. As discussed above, remediation module 212 may shut down operating system 114 in response. Remediation module 212 may also reboot operating system 114 and force this operating system to perform an antivirus scan before completing the restart. Remediation module 212 may also trigger a scan of some or all of virtual machines 112(2)-(N). Additionally or alternatively, remediation module 212 may restrict network access of virtual machine 112(1), thus limiting the potential for malware 120 or the like to spread.

In some instances, remediation module 212 may also change state associated with virtual machine 112(1) in response to detecting an unauthorized change. For instance, imagine that protection agent 130 detects that one of operating-system resources 118 (e.g., the service dispatch table) has been changed, without authorization, from a first state to a second state. In response, remediation module 212 may change this state back to the first state. Additionally, if protection agent 130 determines that malware 120 is hooked into the kernel of operating system 114, then remediation module 212 may unhook this malware.

Having captured and/or inspected a state of the virtual machine 112(1), host 110 may send an instruction to virtual machine monitor 108 to resume operating system 114. Resume module 138 receives this request and, in response, resumes progress of threads running within operating system 114. These threads resume at a point at which they were originally suspended. The servicing of interrupts within virtual machine 112(1) also resumes. The amount of time between the suspending of the operating system and this resumption may be configured such that the suspension is unperceivable to the user of virtual machine 112(1).

Illustrative Processes

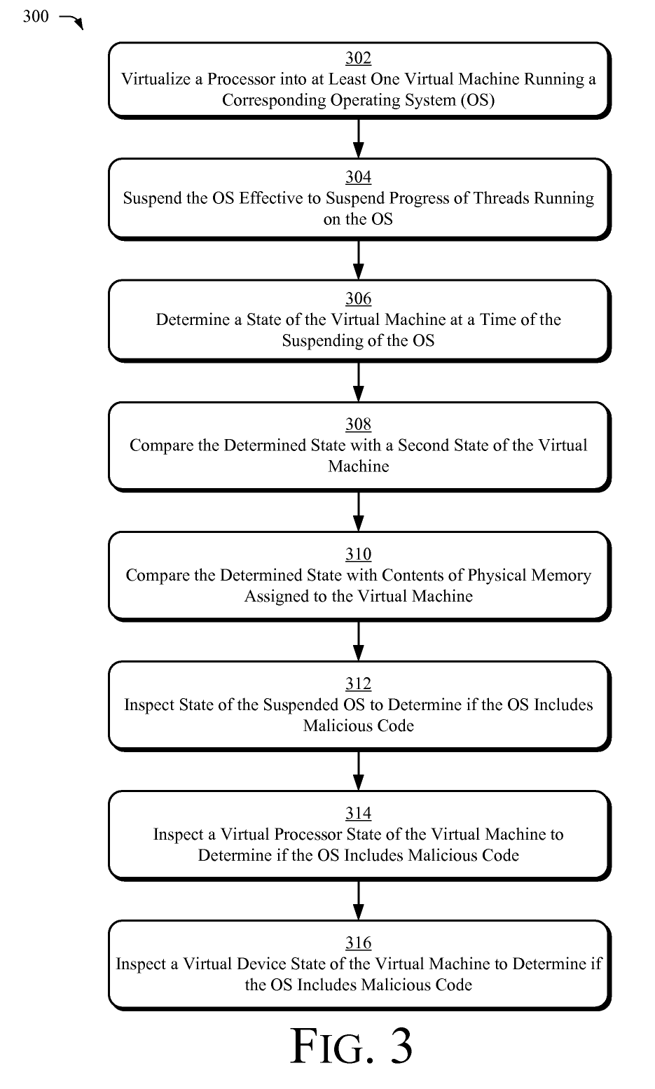

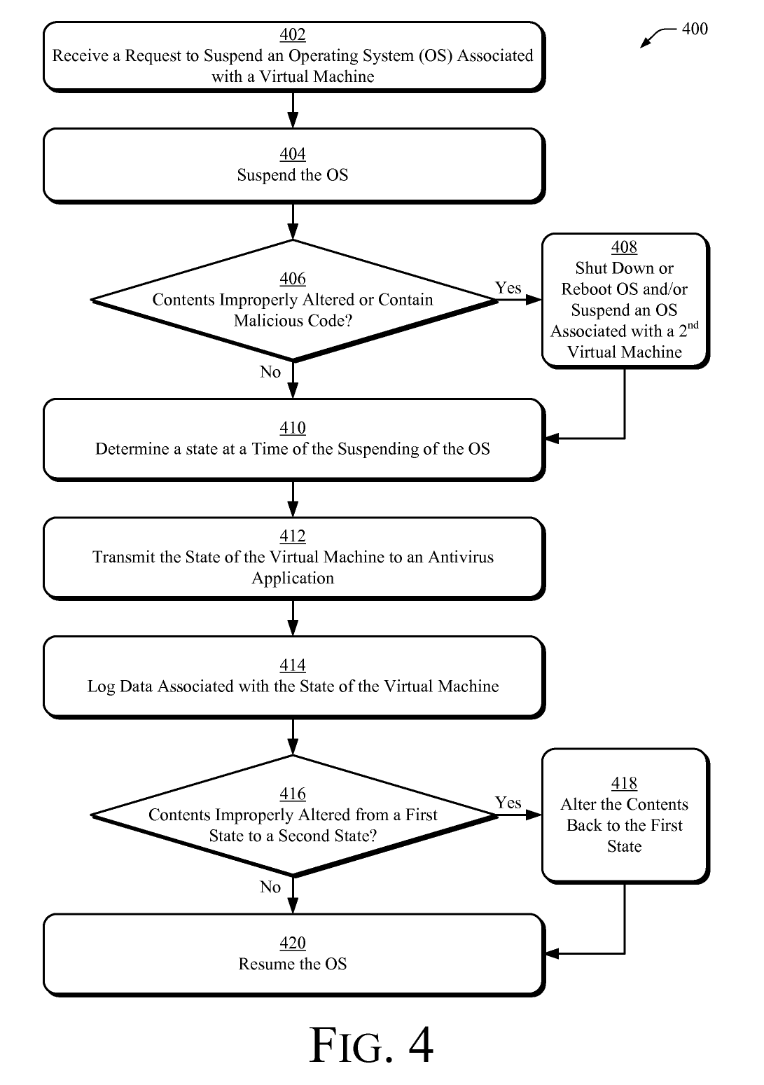

FIGS. 3-4 illustrate illustrative processes 300 and 400 for implementing the suspending of an operating system of a virtual machine, as described with reference to FIGS. 1-2. Processes 300 and 400, as well as other described processes, are illustrated as collections of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

Process 300 includes operation 302, which virtualizes a processor into at least one virtual machine running a corresponding operating system. A virtual machine monitor may virtualize this processor in some instances. Operation 304 then represents suspending the operating system effective to suspend progress of threads running on the operating system. This suspending is also effective to enable a determination of whether contents associated with the virtual machine have been improperly altered or contain malicious code. At operation 306, a state of the virtual machine is determined for a time corresponding to the suspending of the operating system.

Operation 308 then compares this state with a second state of the virtual machine. This second state may correspond to a time prior to the suspending of the operating system and may represent a state of the operating system when suspended or when offline. At operation 310, the determined state is compared with contents of physical memory assigned to the virtual machine. Operation 312, meanwhile, inspects the determined state of the suspended operating system to determine if the operating system includes malicious code. Next, operation 314 inspects a virtual processor state of the virtual machine to determine if the operating system includes malicious code. In some instances, this virtual processor state includes content of processor registers for the virtual machine. Finally, operation 316 inspects a virtual device state of the virtual machine to determine if the operating system includes malicious code. This virtual device state may include contents of hardware peripherals for the virtual machine.

Process 400, meanwhile, includes operation 402, which receives a request to suspend an operating system associated with a virtual machine. Operation 404 then suspends the operating system. Operation 406, meanwhile, queries whether contents of the operating system have been improperly altered or whether the contents contain malicious code. If this query is affirmatively answered, then operation 408 shuts down or reboots the operating system and/or suspends an operating system associated with a second virtual machine. If the query from operation 406 is answered negatively, however, then operation 410 determines a state of the virtual machine at a time of the suspending of the operating system.

At operation 412, the state of the virtual machine is transmitted to an antivirus application to scan the state. Operation 414, meanwhile, logs data associated with the state of the virtual machine. Next, operation 416 queries whether contents of the virtual machine have been improperly altered from a first state to a second state. If these contents have been so altered, then operation 418 alters the contents back to the first state. If the query from operation 416 is answered negatively, however, then operation 420 resumes the operating system associated with the virtual machine.

Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable media storing computer-executable instructions that, when executed on one or more processors, performs acts comprising:
virtualizing a processor into at least one virtual machine running a corresponding operating system; and
suspending the operating system effective to suspend progress of threads running on the operating system and effective to enable a determination of whether contents associated with the virtual machine have been improperly altered or contain malicious code.

2. One or more computer-readable media as recited in claim 1, further comprising:
determining a first state of the virtual machine at a time of the suspending of the operating system; and
comparing the first state of the virtual machine with a second state of the virtual machine, the second state corresponding to a time prior to the suspending of the operating system.

3. One or more computer-readable media as recited in claim 1, further comprising inspecting state of the suspended operating system to determine if the operating system includes malicious code.

4. One or more computer-readable media as recited in claim 1, further comprising inspecting a virtual processor state of the virtual machine to determine if the operating system includes malicious code, the virtual processor state including contents of one or more processor registers for the virtual machine.

5. One or more computer-readable media as recited in claim 1, further comprising inspecting a virtual device state of the virtual machine to determine if the operating system includes malicious code, the virtual device state including contents of hardware peripherals for the virtual machine.

6. One or more computer-readable media as recited in claim 1, further comprising:
determining a state of the virtual machine at a time of the suspending of the operating system; and
comparing the state of the virtual machine with contents of physical memory assigned to the virtual machine.

7. One or more computer-readable media storing computer-executable instructions that, when executed on one or more processors, performs acts comprising:
receiving, at a virtual machine monitor, a request to suspend an operating system associated with a virtual machine; and
suspending, by the virtual machine monitor, the operating system associated with the virtual machine, the suspending effective to enable a determination of whether contents associated with the virtual machine have been improperly altered or contain malicious code.

8. One or more computer-readable media as recited in claim 7, wherein the suspending includes suspending threads scheduled to run on the operating system.

9. One or more computer-readable media as recited in claim 7, wherein the suspending includes ceasing service of interrupts within the virtual machine.

10. One or more computer-readable media as recited in claim 7, wherein the request to suspend the operating system is received according to a periodic schedule.

11. One or more computer-readable media as recited in claim 7, further comprising:
determining if the contents associated with the virtual machine have been improperly altered or contain malicious code; and
shutting down or rebooting the operating system responsive to determining that the contents have been improperly altered or contain malicious code.

12. One or more computer-readable media as recited in claim 7, wherein the virtual machine is a first virtual machine, and further comprising:
determining if the contents associated with the first virtual machine have been improperly altered or contain malicious code; and
responsive to determining that the contents have been improperly altered or contain malicious code, suspending an operating system associated with a second virtual machine to determine if contents associated with the second virtual machine have been improperly altered or contain malicious code.

13. One or more computer-readable media as recited in claim 7, further comprising:
determining a state of the virtual machine at a time of the suspending of the operating system; and
transmitting the state of the virtual machine to an antivirus application to determine if the first state includes malicious code.

14. One or more computer-readable media as recited in claim 7, further comprising:
determining a state of the virtual machine at a time of the suspending of the operating system; and
logging data associated with the state of the virtual machine.

15. One or more computer-readable media as recited in claim 7, further comprising resuming, by the virtual machine monitor, the operating system associated with the virtual machine.

16. One or more computer-readable media as recited in claim 7, further comprising:
determining that the contents associated with the virtual machine have been improperly altered from a first state to a second state;
altering the contents that have improperly altered from the second state back to the first state; and
resuming the operating system associated with the virtual machine.

17. One or more computer-readable media capable of suspending an operating system associated with a virtual machine and capturing a snapshot of the virtual machine at a time corresponding to the suspending, wherein the one or more computer-readable media operate outside of the operating system associated with the virtual machine.

18. One or more computer-readable media as recited in claim 17, wherein the snapshot includes one or more of: a virtual processor state of the virtual machine, a virtual device state of the virtual machine, and contents of memory assigned to the virtual machine.

19. One or more computer-readable media as recited in claim 17, wherein the virtual machine is a first virtual machine and wherein the one or more computer-readable media operate within a virtual machine monitor configured to virtualize a processor into one or more virtual machines including the first virtual machine.

20. One or more computer-readable media as recited in claim 17, wherein the one or more computer-readable media are further capable of transmitting the snapshot to an entity configured to determine, with use of the snapshot, if contents associated with the virtual machine contain malicious code or have been improperly altered.
